(19) United States
(12) Patent Application Publication
(10) Pub. No.: US 2024/0309144 A1
(43) Pub. Date: Sep. 19, 2024

(54) SILANE MODIFIED ALIPHATIC POLYUREA

(71) Applicant: EVONIK OPERATIONS GMBH, Essen (DE)

(72) Inventors: Shafiq Fazel, Allentown, PA (US); David Brown, Orwigsburg, PA (US)

(73) Assignee: EVONIK OPERATIONS GMBH, Essen (DE)

(21) Appl. No.: 18/575,612

(22) PCT Filed: Jul. 4, 2022
(86) PCT No.: PCT/EP2022/068371

§ 371 Date: Dec. 29, 2023

Related U.S. Application Data
(60) Provisional application No. 63/221,256, filed on Jul. 13, 2021.

(51) Int. Cl. C08G 18/38; C08K 5/06; C08K 5/11; C09D 7/63; C09D 175/02

(52) U.S. Cl. CPC C08G 18/3821; C08G 18/3893; C08K 5/06; C08K 5/11; C09D 7/63; C09D 175/02; C08G 2150/00

(57) ABSTRACT

The present invention relates to a new curing agent composition and coating composition. The coating composition solves problems with conventional coatings by providing a silane modified aliphatic polyurea coating that improves performance including longer open time and pot-life with fast drying, faster hardness development, improved adhesion to epoxy and other polyurea coatings, and improved chemical resistance. The coating composition is comprised of at least one polyisocyanate resin, and a composition comprising an isocyanate reactive agent containing at least one secondary diamine, at least one silane component and optionally at least one viscosity modifier.

### BACKGROUND OF THE INVENTION

Polyurea coatings are known in the industry for fast curing, ability to cure at wide temperature/humidity range and excellent performance properties. Polyurea coatings are very versatile and have wide-ranging applications as commercial and industrial protective coatings, and some aliphatic polyureas are used as decorative coatings on walls, floors and other surfaces.

Certain prior art polyurea coatings have been known to have deficiencies that inhibit their effectiveness in providing adequate protection to the substrate or to improve properties of the substrate. For example, known polyurea coating compositions may have limited pot-life or working time due to the high level of reactivity between the isocyanate component and the amine component. Also, certain polyurea coating compositions may have poor adhesion properties to a previously applied coating or to the substrate itself and/or exhibit poor durability upon prolonged exposure to ultraviolet radiation and/or humidity conditions.

Considerable efforts have been expended to develop coating compositions with improved performance in terms of protective, aesthetic and handling properties. One example of methods used to overcome some of the deficiencies is to use solvents or volatile organic compounds (VOCs) in the polyurea formulation. However, most VOCs are harmful to both the environment and the applicators who apply the coatings. Also, the use of solvents or VOCs limit the thickness of the coating that can be applied to the substrate.

Accordingly, it is desirable to provide polyurea coating compositions that have improved pot-life or working time without the use of solvents and may enhance adhesion to previously applied coatings or to the substrate, It also desirable to achieve these performance without sacrificing the fast cure speed, great aesthetics and protective properties of polyurea coatings.

### BRIEF SUMMARY OF THE INVENTION

The instant invention can solve problems with conventional coatings by providing a silane modified aliphatic polyurea coating that provides improved performance including longer open time and pot-life with fast drying, faster hardness development, improved adhesion to epoxy and other polyurea coatings, and improved chemical resistance.

One aspect of the invention relates to a composition comprising:
A. an isocyanate reactive agent comprising at least one secondary diamine wherein the secondary diamine comprises the reaction product of at least one diamine and alkyl esters of 2-butendioic acid;
B. at least one silane component; and
C. optionally at least one viscosity modifier.

Another aspect of the invention relates to a coating composition comprising at least one polyisocyanate resin and a composition comprising
A. an isocyanate reactive agent comprising at least one secondary diamine wherein the secondary diamine comprises the reaction product of at least one diamine and alkyl esters of 2-butendioic acid;
B. at least one silane component; and
C. optionally at least one viscosity modifier.
   Preferably, the coating composition is non-aqueous. By “non-aqueous” it is meant that the coating composition comprises less than about 1 weight percent water and typically about 0 weight percent water.

Another aspect of the invention relates to a composition comprising at least one silane component, at least one viscosity modifier, and the reaction product of bis(4-aminocyclohexyl)methane and an ethyl ester of 2-butendioic acid.

A further aspect of the invention relates to a composition comprising at least one silane component, at least one viscosity modifier, and the reaction product of bis(4-amino-3-methylcycohexyl)methane and an ethyl ester of 2-butendioic acid.

The various aspects of the invention can be used alone or in combinations with each other.

### DETAILED DESCRIPTION OF THE INVENTION

The instant invention relates to curing agent compositions, coating compositions and coatings that can be advantageously used to provide protection such as resistance to abrasion, impact, chemical, stain and UV, to a variety of substrates and/or can be used for decorative purposes to enhance the appearance of a certain surface.

The term “coating composition” refers to an uncured fluid composition that is sprayable or that can be brushed/rolled onto a substrate, or into which the substrate can be dipped. The term coating refers to a layer that is derived from the coating composition and is substantially free from water and/or solvent and that has undergone curing in an amount effective to form a thermoset film. The phrase “substantially free from water” means a coating composition comprising less than about 1 weight percent water and typically about 0 weight percent or non-aqueous. A protective coating as defined as one that is disposed directly or indirectly upon the substrate and can comprise one or more layers, one of which is derived from the coating composition. The term “disposed indirectly” refers to a coating that is separated from the substrate by other layers, while the term “disposed directly” refers to layers that are in intimate physical contact with the substrate. While any suitable substrate can be coated, examples of such substrates include at least one of concrete, wood, metal, plastic, composites, among other suitable substrates.

One aspect of the invention relates to a composition comprising:
A. an isocyanate reactive agent comprising at least one secondary diamine wherein the secondary diamine comprises the reaction product of at least one diamine and alkyl esters of 2-butendioic acid;
B. at least one silane component; and
C. optionally at least one viscosity modifier.

Preferably, the composition comprises at least one isocyanate reactive agent comprising at least one secondary diamine formed by reaction of diamines with alkyl esters of 2-butendioic acid. The secondary diamine product has the general formula (I):

R¹O₂CCH₂CH(CO₂R²)NH—X—NHCH(CO₂R³)CH₂CO₂R⁴ (I)

wherein R¹, R², R³, and R⁴ are the same or different and each are alkyl groups having an amount of about 1 to about 12 carbon atoms.

Preferably, in one embodiment, the alkyl groups of the secondary diamine product have an amount of 1 to about 4 carbon atoms; and X—represents a divalent hydrocarbon group obtained by the removal of the amino groups from at least one of 1,4-diaminobutane, 1,6-diaminohexane, 2,2,4- and/or 2,4,4-trimethyl-1,6-diaminohexane, 1-amino-3,3,5-trimethyl-5-aminomethyl-cyclohexane, bis(4-aminocyclohexyl)methane, bis(4-amino-3-methylcycohexyl)methane, ethylene diamine, 1,2-diaminopropane, 1,4-diaminobutane, 2,5-diamino-2,5-dimthylhexane, 1, 11-diaminoundecane, 1,12-diaminododecane, 2,4′ and ′ or 2,6-hexahydrotoluyene diamine, 2,4- and/or 2,6-diaminotoluene and 2,4- and/or 4,4′diaminodiphenyl methane, and polyetherdiamines. An exemplary alkyl group is an ethyl group. The amount of the isocyanate reactive agent typically ranges from about 20 to about 70 wt %; including about 25 to about 65 wt %; and about 30 to about 60 wt % of the coating composition. The amine equivalent weight can range from about 100 to about 500 including about 150 to about 450; and about 200 to about 400.

Preferably, in one embodiment, the composition comprises at least one silane component comprising an alkoxy-functional silane, wherein the alkoxy-functional silane comprises a compound represented by the general formula:

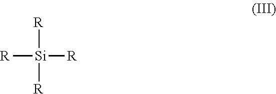

wherein each R, which may be the same or different, is selected from the group consisting of an alkyl group having up to six carbon atoms, an aryl group having up to six carbon atoms, and an alkoxy group having up to six carbon atoms; or wherein each R, which may be the same or different, is selected from the group consisting of hydrogen, an alkyl group having up to six carbon atoms, and an aryl group having up to six carbon atoms.

Preferably, the alkoxy-functional silane comprises at least one member selected from the group consisting of trimethyl-methoxysilane, trimethylethoxysilane, triethyl-methoxysilane, trimethylisopropoxysilane, trimethyl-butoxysilane, triphenylmethoxysilane, dimethyl-t-butylmethoxysilane, triphenylethoxysilane, dimethyl-phenylmethoxysilane; dimethyl-dimethoxysilane, dimethyldiethoxysilane, diethyl-dimethoxysilane, diphenyldimethoxysilane, diphenyl-diethoxysilane, methylphenyldimethoxysilane methyl-phenyldiethoxysilane; methyl-trimethoxysilane, methyltriethoxysilane, ethyltri-methoxysilane, phenyltrimethoxysilane phenyltri-ethoxysilane; tetramethoxysilane, tetraethoxysilane and tetraiso-propoxysilane.

Preferably, in one embodiment, the secondary diamine comprises the reaction product of bis(4-aminocyclohexyl)methane and ethyl ester of 2-butendioic acid.

Preferably, in one embodiment, the secondary diamine comprises the reaction product of bis(4-amino-3-methylcycohexyl)methane and ethyl ester of 2-butendioic acid.

Preferably, in any of the previous embodiments, the composition is a curing composition.

Another aspect of the invention relates to a coating composition comprising at least one polyisocyanate resin and a composition comprising
A. an isocyanate reactive agent comprising at least one secondary diamine wherein the secondary diamine comprises the reaction product of at least one diamine and alkyl esters of 2-butendioic acid;
B. at least one silane component; and
C. optionally at least one viscosity modifier.

Preferably, the coating composition is non-aqueous. By “non-aqueous” it is meant that the coating composition comprises less than about 1 weight percent water and typically about 0 weight percent water.

Preferably, the coating composition comprises at least one isocyanate reactive agent comprising at least one secondary diamine formed by reaction of diamines with alkyl esters of 2-butendioic acid. The secondary diamine product has the general formula (I):

R¹O₂CCH₂CH(CO₂R²)NH—X—NHCH(CO₂R³)CH₂CO₂R⁴ (I)

wherein R¹, R², R³, and R⁴ are the same or different and each are alkyl groups having an amount of about 1 to about 12 carbon atoms.

Preferably, in one embodiment, the alkyl groups of the secondary diamine product have an amount of 1 to about 4 carbon atoms; and X-represents a divalent hydrocarbon group obtained by the removal of the amino groups from at least one of 1,4-diaminobutane, 1,6-diaminohexane, 2,2,4- and/or 2,4,4-trimethyl-1,6-diaminohexane, 1-amino-3,3,5-trimethyl-5-aminomethyl-cyclohexane, bis(4-aminocyclohexyl)methane, bis(4-amino-3-methylcycohexyl)methane, ethylene diamine, 1,2-diaminopropane, 1,4-diaminobutane, 2,5-diamino-2,5-dimthylhexane, 1,11-diaminoundecane, 1,12-diaminododecane, 2,4′ and ′ or 2,6-hexahydrotoluyene diamine, 2,4- and/or 2,6-diaminotoluene and 2,4- and/or 4,4′diaminodiphenyl methane, and polyetherdiamines. An exemplary alkyl group is an ethyl group. The amount of the isocyanate reactive agent typically ranges from about 20 to about 70 wt %; including about 25 to about 65 wt %; and about 30 to about 60 wt % of the coating composition. The amine equivalent weight can range from about 100 to about 500 including about 150 to about 450; and about 200 to about 400.

Preferably, the coating composition comprises at least one polyisocyanate resin, wherein the at least one polyisocyanate resin comprises an isocyanate functional compound having the general formula:

R(NCO)i, (II)

wherein R is an organic radical having the valence of i, wherein i is greater than or equal to about 2. Preferably, R can be a substituted or unsubstituted hydrocarbon group (e.g., a methylene group or an arylene group).

The isocyanates can be aromatic or aliphatic. Useful aromatic diisocyanates can comprise, for example, 2,4-toluene diisocyanate and 2,6-toluene diisocyanate (each generally referred to as TDI); mixtures of the two TDI isomers; 4,4′-diisocyanatodiphenylmethane (MDI); p-phenylene diisocyanate (PPDI); diphenyl-4,4′-diisocyanate; dibenzyl-4,4′-diisocyanate; stilbene-4,4′-diisocyanate; benzophenone-4,4′-diisocyanate; 1,3- and 1,4-xylene diisocyanates; or the like, or a combination comprising at least one of the foregoing aromatic isocyanates. Exemplary aromatic diisocyanates for the preparation of polyurethane prepolymers include TDI, MDI, and PPDI.

Useful aliphatic diisocyanates can comprise, for example, 1,6-hexamethylene diisocyanate (HDI); 1,3-cyclohexyl diisocyanate; 1,4-cyclohexyl diisocyanate (CHDI); the saturated diphenylmethane diisocyanate known as H(12)MDI; (also known commercially as bis{4-isocyanatocyclohexyl}methane, 4,4′-methylene dicyclohexyl diisocyanate, 4,4-methylene bis(dicyclohexyl)diisocyanate, methylene dicyclohexyl diisocyanate, methylene bis(4-cyclohexylene isocyanate), saturated methylene diphenyl diisocyanate, and saturated methyl diphenyl diisocyanate), isophorone diisocyanate (IPDI); or the like; or a combination comprising at least one of the foregoing isocyanates. An exemplary aliphatic diisocyanate is H(12)MDI.

Other exemplary polyisocyanates include hexamethylene diisocyanate (HDI), 2,2,4- and/or 2,4,4-trimethyl-1,6-hexamethylene diisocyanate, dodecamethylene diisocyanate, 1,4-diisocyanatocyclohexane, 1-isocyanato-3,3,5-trimethyl-5-isocyanatomethylcyclohexane (IPDI), 2,4′- and/or 4,4′-diisocyanato-dicyclohexyl methane, 2,4- and/or 4,4′-diisocyanato-diphenyl methane and mixtures of these isomers with their higher homologues which are obtained by the phosgenation of aniline/formaldehyde condensates, 2,4- and/or 2,6-diisocyanatotoluene and any mixtures of these compounds. Higher functional hexamethylenediisocyanate (HDI) polyisocyanates such as biurets, trimers, and dimers, was found to be particularly useful for purposes of the present invention. The amount of polyisocyanate typically ranges from about 10 to about 60 wt % including about 25 to about 55 wt %; and about 20 to about 50 wt % of the coating composition.

In one aspect of the invention, R in the formula (II) can also represent a polyurethane radical having a valence of i, in which case R(NCO)i is a composition known as an isocyanate-terminated polyurethane prepolymer or semi-prepolymer. Prepolymers or semi-prepolymers are formed when an excess of organic diisocyanate monomer is reacted with an active hydrogen containing component.

The inventive composition also comprise at least one silane component. The coating compositions of the present invention comprise an alkoxy-functional silane. As used herein, the term “alkoxy functional silane and/or silanol-functional silicone ′ refers to silicones comprising alkoxy-functional groups,—wherein R is an alkyl group or an aryl group.

As used herein, the term ‘silicone’ refers to siloxane polymers based on a structure comprising alternate silicon and oxygen atoms.

Preferably, in one embodiment, the coating composition comprises at least one silane component comprising an alkoxy-functional silane, wherein the alkoxy-functional silane comprises a compound represented by the general formula:

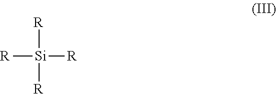

wherein each R, which may be the same or different, is selected from the group consisting of an alkyl group having up to six carbon atoms, an aryl group having up to six carbon atoms, and an alkoxy group having up to six carbon atoms; or wherein each R, which may be the same or different, is selected from the group consisting of hydrogen, an alkyl group having up to six carbon atoms, and an aryl group having up to six carbon atoms. In certain embodiments, each R can comprise an alkyl, aryl or alkoxy group having less than six carbon atoms to facilitate rapid hydrolysis, which reaction is driven by the volatility of the alcohol analog product of the hydrolysis.

Preferably, the alkoxy-functional silane comprises at least one member selected from the group consisting of trimethyl-methoxysilane, trimethylethoxysilane, triethyl-methoxysilane, trimethylisopropoxysilane, trimethyl-butoxysilane, triphenylmethoxysilane, dimethyl-t-butylmethoxysilane, triphenylethoxysilane, dimethyl-phenylmethoxysilane; dimethyl-dimethoxysilane, dimethyldiethoxysilane, diethyl-dimethoxysilane, diphenyldimethoxysilane, diphenyl-diethoxysilane, methylphenyldimethoxysilane methyl-phenyldiethoxysilane; methyl-trimethoxysilane, methyltriethoxysilane, ethyltri-methoxysilane, phenyltrimethoxysilane phenyltri-ethoxysilane; tetramethoxysilane, tetraethoxysilane and tetraiso-propoxysilane.

Examples of Alkoxysilanes of the present invention include monoalkoxysilanes such as trimethyl-methoxysilane, trimethylethoxysilane, triethyl-methoxysilane, trimethylisopropoxysilane, trimethyl-butoxysilane, triphenylmethoxysilane, dimethyl-t-butylmethoxysilane, triphenylethoxysilane, and dimethyl-phenylmethoxysilane; dialkoxysilanes such as dimethyl-dimethoxysilane, dimethyldiethoxysilane, diethyl-dimethoxysilane, diphenyldimethoxysilane, diphenyl-diethoxysilane, methylphenyldimethoxysilane and methyl-phenyldiethoxysilane; trialkoxysilanes such as methyl-trimethoxysilane, methyltriethoxysilane, ethyltri-methoxysilane, phenyltrimethoxysilane and phenyltri-ethoxysilane; as well as tetraalkoxysilanes such as tetramethoxysilane, tetraethoxysilane and tetraiso-propoxysilane. The amount of silane typically ranges from about 1 to about 30 wt % including about 5 to about 25 wt %; and about 10 to about 20 wt % of the coating composition.

The other optional silane components include the adducts of isocyanatoalkyltrialkoxysilanes and aliphatic, alkyl branched diols or polyols as described in patent US2013/0244043 (Evonik). Preferably, in one embodiment, the coating composition comprises at least one silane component wherein the at least one silane component is selected from the group consisting of adducts of isocyanatoalkyltrialkoxysilanes; aliphatic, alkyl branched diols; and aliphatic, alkyl branched polyols.

Commerical products include Vestanat EP-M 60, EP-M 95, EP-MF 203, EP-MF 204, EP-MF 205, EP-EF 201, and EP-EF 202 etc.

The coating composition can also comprise of at least one viscosity modifier. A viscosity modifier can comprise of at least one polar or nonpolar solvent or non-reacting diluent. Preferably, the coating composition can also comprise of at least one viscosity modifier, wherein the at least one viscosity modifier comprises at least one solvent selected from the group consisting of hexane, heptane, xylene, toluene, cyclohexane; ester type one such as methyl acetate, ethyl acetate, t-butyl acetate, acetic acid ethylene glycol monomethyl ether, 1,2,3-triacetoxypropane, acetic acid diethylene glycol monomethyl ether, dibasic ester; ether type one such as isopropyl ether, ethylene glycol monomethyl ether, diethylene glycol monobutyl ether; ketone type such as methyl isobutyl ketone, methyl ethyl ketone, isophorone, acetophenone; carbonate type such as propylene carbonate, dimethyl carbonate; Pyrollidone type such as n-methyl pyrollidone, n-ethyl pyrollidone; halogenated solvent type such as parachlorobenzotrifluoride, 1,1,2,2-Tetrachloroethane, 1,1-Dichloroethane and any other protic or aprotic solvent that are inert towards amines or polyisocyanates. Preferably, the coating composition can also comprise of at least one viscosity modifier, wherein the at least one viscosity modifier comprises at least one non-reacting diluent selected from the group consisting of phthalate type such as bis(2-ethylhexyl) phthalate, diisononyl phthalate, butyl benzyl phthalate; ester type such as dioctyl adipate, dibutyl sebacate, 1,2-Cyclohexane dicarboxylic acid diisononyl ester, 2,2,4-Trimethyl-1,3-pentanediol diisobutyrate, alkyl sulphonic acid phenyl ester; citrate types such as acetyl triethyl citrate, triethyl citrate; trimellitate type such as trimethyl trimellitate, tri-(2-ethylhexyl) trimellitate and other class of non-reacting diluents such as benzoates, sulfonamides, epoxidized vegetable oils, organophosphates, glycols, polyethers, polybutene and combinations thereof. The amount of viscosity modifier typically ranges from about 2 to about 30 wt % including about 5 to about 25 wt %; and about 10 to about 20 wt % of the coating composition.

Preferably, the coating composition can also comprise of at least one other additive selected from the group consisting of leveling agents, defoamers, air release agents, antioxidants, UV stabilizers, rheology modifier, pigments, dispersants, plasticizers, diluents, fillers and combinations thereof. The amount of these additives typically ranges from about 0 to about 10% including about 1 to about 5 wt %; and about 2 to about 5 wt % of the coating composition.

Preferably, in any of the previous embodiments, the coating composition is non-aqueous.

### EXAMPLES

The components of the inventive coating composition can be combined by using any suitable conventional equipment and methods. Examples of the foregoing include a blender, agitation with impeller blade, hand mixing with stirring stick, speed mixer among other conventional equipment.

The components of the coating composition are typically combined in the following order: 1) Isocyanate reactive agent(s), 2) viscosity modifier(s), 3) silane(s), 4) additive(s) (mixed until solution is homogeneous); and 5) polyisocyanate.

The various aspects of this invention can be used alone or in combination. Certain aspects of the invention are illustrated by the following Examples. These Examples shall not limit the scope of the appended claims.

The following ingredients used in the formulations are shown in Table 1:

TABLE 1

| Ingredients | Details |
|---|---|
| Commercial diamine A | Amicure ® IC-221 from Evonik Corporation |
| Commercial diamine B | Amicure ® IC-321 from Evonik Corporation |
| Secondary diamine A | A reaction product of bis(4- |
| | aminocyclohexyl)methane and ethyl ester |
| | of 2-butendioic acid |
| Secondary diamine B | A reaction product of bis(4-amino-3- |
| | methylcycohexyl)methane and ethyl ester |
| | of 2-butendioic acid |

### Example 1

The first example shows coating compositions comprising a secondary diamine product as shown in Table 1, both as-is and blended with, i.e. without and with, commercial silanes from Evonik Corporation. Then the polyisocyanate, hexamethylene diisocyanate trimer is added to the isocyanate reactive mixture at a stoichiometric ratio of 1.05 NCO to amine and mixed together using a speedmixer to form a homogenous mixture before applying. Cure properties of the mixture and dry film were used using various test procedures. Samples containing blends of diamines with silanes show low mix viscosity with high final hardness as measured by Persoz pendulum testing.

TABLE 2

| | Sample | Sample | Sample | Sample | Sample | Sample | Sample | Sample |
|---|---|---|---|---|---|---|---|---|
| | 1A | 1B | 1C | 1D | 1E | 1F | 1G | 1H |
| | wt % | wt % | wt % | wt % | wt % | wt % | wt % | wt % |
| Commercial Aliphatic | | | | | | | | |
| polyurea product | | | | | | | | |
| Commercial diamine A | 100 | | | | | | | |
| Commercial diamine B | | 100 | | | | | | |
| Secondary Diamine A | | | 100 | 37.5 | 75 | 75 | 37.5 | 37.5 |
| Secondary Diamine B | | | | 37.5 | | | 37.5 | 37.5 |
| Silane | | | | | | | | |
| Vestanat EP- M 60 | | | | | 25 | | 25 | |
| Vestanat EP- M 95 | | | | | | 25 | | 25 |
| Amine eq. wt | 375 | 376 | 276 | 280 | 375 | 375 | 380 | 380 |

TABLE 3
Cure Properties of the aliphatic polyurea mixture

| | Sample | Sample | Sample | Sample | Sample | Sample | Sample | Sample |
|---|---|---|---|---|---|---|---|---|
| | 1A | 1B | 1C | 1D | 1E | 1F | 1G | 1H |
| Viscosity cure profile (time to 12,000 cP)¹ | 27.5 | 50 | 11.5 | 13.5 | 18 | 14 | 29 | 24 |
| Initial viscosity of mixture (cP)¹ | 1383 | 1083 | 3483 | 3900 | 2083 | 2567 | 1967 | 2283 |
| Dry times (set-to-touch/tack free) - minutes² | 11.25/28.75 | 25/75 | 6.25/15 | 12.5/37.5 | 6.9/16.3 | 4.7/16.9 | 32.5/68.75 | 22.5/63.75 |
| Persoz Hardeness (24 hrs)³ | 197 | 132 | 348 | 229 | 314 | 277 | 279 | 231 |

### Example 2

The second example shows coating compositions comprising of secondary diamine(s) blended with silanes and viscosity modifier. Then the polyisocyanate, hexamethylene diisocyanate trimer is added to the isocyanate reactive mixture at a stoichiometric ratio of 1.05 NCO to amine and mixed together using a speedmixer to form a homogeneous mixture before applying. Cure properties of the mixture and dry film are compared to that of commercial diamines containing no silane components. The data shows long cure profile time, low mix viscosity with high hardness development in 3 days.

Intercoat adhesion of the samples was tested over two different organic coating substrates. The sample coatings were applied as topcoat over the substrates, aliphatic polyurea coating and an epoxy coating. The aliphatic polyurea coating was the Amicure IC-221 and the epoxy coating was the Ancamine 2850 cured with liquid epoxy resin. Both material were supplied by Evonik Corporation. The topcoats were applied at different time intervals after the initial coatings of Amicure IC-221 and Ancamine 2850 were applied. Sample 2F and 2G showed excellent adhesion to both aliphatic polyurea 5 and epoxy coating even after 3 months.

TABLE 4

| | Sample | Sample | Sample | Sample | Sample | Sample | Sample |
|---|---|---|---|---|---|---|---|
| | 2A | 2B | 2C | 2D | 2E | 2F | 2G |
| | wt % | wt % | wt % | wt % | wt % | wt % | wt % |
| Commercial Aliphatic polyurea product | | | | | | | |
| Commercial diamine A | 100 | | | | | | |
| Commercial diamine B | | 100 | | | | | |
| Secondary Diamine A | | | 37.5 | 37.5 | 37.5 | 37.5 | 37.5 |
| Secondary Diamine B | | | 37.5 | 37.5 | 37.5 | 37.5 | 37.5 |
| Silane | | | | | | | |
| Vestanat EP- M 60 | | | 12.5 | | | | |
| Vestanat EP- MF 203 | | | | 12.5 | | | |
| Trimethoxypropylsilane | | | | | 12.5 | | |
| Trimethoxymethylsilane | | | | | | 12.5 | 12.5 |
| Viscosity modifier | | | | | | | |
| Butyl diglyme | | | 12.5 | 12.5 | 12.5 | 12.5 | |
| 1,2,3-triacetoxypropane | | | | | | | 12.5 |
| Amine eq. wt | 375 | 376 | 276 | 280 | 375 | 375 | 380 |

TABLE 5

| | Sample | Sample | Sample | Sample | Sample | Sample | Sample |
|---|---|---|---|---|---|---|---|
| | 2A | 2B | 2C | 2D | 2E | 2F | 2G |
| Viscosity cure profile (time to 12,000 cP)¹ | 27.5 | 50 | 95 | 92 | 52 | 114 | 90 |
| Initial viscosity of mixture (cP)¹ | 1383 | 1083 | 717 | 717 | 383 | 383 | 633 |
| Dry times (set-to-touch/tack free) - minutes² | 11.25/28.75 | 25/75 | 46.25/95 | 42.5/95 | 27.5/55 | 37.5/88.75 | 37.5/97.5 |
| Persoz Hardeness (3 days)³ | 216 | 167 | 278 | 284 | 313 | 220 | 228 |

¹Vicosity cure profile and initial mixed viscosity measured using Brookfield Viscometer with Thermosel Accessory, Stand Alone (ASTM D2196)
²Dry times of curing film at 6 mil thickness was measured using ASTM D5895.
³Persoz hardness of thin film with thickness around 6-8 mils was measured using ASTM D4366.

TABLE 6
Intercoat adhesion testing of aliphatic polyurea coatings over organic coating
substrates (Aliphatic polyurea and epoxy) at various time intervals

| | | Sample | Sample | Sample | Sample | Sample | Sample | Sample |
|---|---|---|---|---|---|---|---|---|
| Adhesion to Substrate⁴ | | 2A | 2B | 2C | 2D | 2E | 2F | 2G |
| Aliphatic Polyurea coating | | | | Not | | | | |
| (Amicure IC-221) | | | | tested | | | | |
| Topcoat applied after | | | | | | | | |
| 24 | hrs | 5A | 5A | | 5A | 5A | 5A | 5A |
| 1 | Week | 5A | 5A | | 5A | 5A | 5A | 5A |
| 2 | weeks | 5A | 5A | | 5A | 5A | 5A | 5A |
| >3 | months | 0A | 0A | | ND | ND | 5A | 5A |
| Epoxy coating (Ancamine) | | | | | | | | |
| Topcoat applied after | | | | | | | | |
| 24 | hrs | 0A | ND | | 5A | ND | 5A | 5A |
| 1 | Week | 5A | ND | | 5A | ND | 5A | 5A |
| 2 | weeks | 4A | 0A | | 5A | ND | 5A | 5A |
| >3 | months | 0A | 0A | | ND | ND | 5A | 5A |

⁴Cross Cut Tape Adhesion using ASTM method D3359 method A. The rating is given from 0A to 5A with 5A being the best.

The present invention is not to be limited in scope by the specific aspects or embodiments disclosed in the examples which are intended as illustrations of a few aspects of the invention and any embodiments that are functionally equivalent are within the scope of this invention. Various modifications of the invention in addition to those shown and described herein will become apparent to those skilled in the art and are intended to fall within the scope of the appended claims.

1. A composition comprising:
an isocyanate reactive agent comprising at least one secondary diamine wherein the secondary diamine comprises the reaction product of at least one diamine and alkyl esters of 2-butendioic acid;
at least one silane component; and
optionally at least one viscosity modifier.

2. The composition of claim 1 wherein the isocyanate reactive agent has the general formula (I):
R¹O₂CCH₂CH(CO₂R²)NH—X—NHCH(CO₂R³)CH₂CO₂R⁴ (I)
wherein R¹, R², R³, and R⁴ are the same or different and each are alkyl groups having an amount of about 1 to about 12 carbon atoms.

3. The composition of claim 2 wherein the alkyl groups have 1 to about 4 carbon atoms; and X-represents a divalent hydrocarbon group obtained by the removal of the amino groups from at least one of 1,4-diaminobutane, 1,6-diaminohexane, 2,2,4- and/or 2,4,4-trimethyl-1,6-diaminohexane, 1-amino-3,3,5-trimethyl-5-aminomethyl-cyclohexane, bis(4-aminocyclohexyl)methane, bis(4-amino-3-methylcycohexyl)methane, ethylene diamine, 1,2-diaminopropane, 1,4-diaminobutane, 2,5-diamino-2,5-dimthylhexane, 1,11-diaminoundecane, 1,12-diaminododecane, 2,4′ and ′ or 2,6-hexahydrotoluyene diamine, 2,4- and/or 2,6-diaminotoluene and 2,4- and/or 4,4′diaminodiphenyl methane, and polyetherdiamines.

4. The composition of claim 1 wherein the at least one silane component comprises an alkoxy-functional silane, wherein the alkoxy-functional silane comprises a compound represented by the general formula: 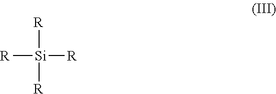
wherein each R, which may be the same or different, is selected from the group consisting of an alkyl group having up to six carbon atoms, an aryl group having up to six carbon atoms, and an alkoxy group having up to six carbon atoms; or wherein each R, which may be the same or different, is selected from the group consisting of hydrogen, an alkyl group having up to six carbon atoms, and an aryl group having up to six carbon atoms.

5. The composition of claim 4 wherein the alkoxy-functional silane comprises at least one member selected from the group consisting of trimethyl-methoxysilane, trimethylethoxysilane, triethyl-methoxysilane, trimethylisopropoxysilane, trimethyl-butoxysilane, triphenylmethoxysilane, dimethyl-t-butylmethoxysilane, triphenylethoxysilane, dimethyl-phenylmethoxysilane; dimethyl-dimethoxysilane, dimethyldiethoxysilane, diethyl-dimethoxysilane, diphenyldimethoxysilane, diphenyl-diethoxysilane, methylphenyldimethoxysilane methyl-phenyldiethoxysilane; methyl-trimethoxysilane, methyltriethoxysilane, ethyltri-methoxysilane, phenyltrimethoxysilane phenyltri-ethoxysilane; tetramethoxysilane, tetraethoxysilane and tetraiso-propoxysilane.

6. The composition of claim 1 wherein the secondary diamine comprises the reaction product of bis(4-aminocyclohexyl)methane and ethyl ester of 2-butendioic acid.

7. The composition of claim 1 wherein the secondary diamine comprises the reaction product of bis(4-amino-3-methylcycohexyl)methane and ethyl ester of 2-butendioic acid.

8. The composition of claim 1 wherein the composition is a curing composition.

9. A coating composition comprising at least one polyisocyanate resin and the composition according to claim 1 comprising
an isocyanate reactive agent comprising at least one secondary diamine, wherein the secondary diamine comprises the reaction product of at least one diamine and alkyl esters of 2-butendioic acid;
at least one silane component; and
optionally at least one viscosity modifier.

10. The coating composition of claim 9 wherein the isocyanate reactive agent has the general formula (I):
R¹O₂CCH₂CH(CO₂R²)NH—X—NHCH(CO₂R³)CH₂CO₂R⁴ (I)
wherein R¹, R², R³, and R⁴ are the same or different and each are alkyl groups having an amount of about 1 to about 12 carbon atoms.

11. The coating composition of claim 10 wherein the alkyl groups have 1 to about 4 carbon atoms; and X-represents a divalent hydrocarbon group obtained by the removal of the amino groups from at least one of 1,4-diaminobutane, 1,6-diaminohexane, 2,2,4- and/or 2,4,4-trimethyl-1,6-diaminohexane, 1-amino-3,3,5-trimethyl-5-aminomethyl-cyclohexane, bis(4-aminocyclohexyl)methane, bis(4-amino-3-methylcycohexyl)methane, ethylene diamine, 1,2-diaminopropane, 1,4-diaminobutane, 2,5-diamino-2,5-dimthylhexane, 1,11-diaminoundecane, 1,12-diaminododecane, 2,4′ and ′ or 2,6-hexahydrotoluyene diamine, 2,4- and/or 2,6-diaminotoluene and 2,4- and/or 4,4′diaminodiphenyl methane, and polyetherdiamines.

12. The coating composition of claim 9 wherein the at least one polyisocyanate resin comprises an isocyanate functional compound having the general formula:
R(NCO)i, (II)
wherein R is an organic radical having the valence of i, wherein i is greater than or equal to about 2.

13. The coating composition of claim 9 wherein the at least one silane component comprises an alkoxy-functional silane, wherein the alkoxy-functional silane comprises a compound represented by the general formula: 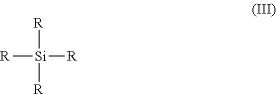
wherein each R, which may be the same or different, is selected from the group consisting of an alkyl group having up to six carbon atoms, an aryl group having up to six carbon atoms, and an alkoxy group having up to six carbon atoms; or wherein each R, which may be the same or different, is selected from the group consisting of hydrogen, an alkyl group having up to six carbon atoms, and an aryl group having up to six carbon atoms.

14. The coating composition of claim 13 wherein the alkoxy-functional silane comprises at least one member selected from the group consisting of trimethyl-methoxysilane, trimethylethoxysilane, triethyl-methoxysilane, trimethylisopropoxysilane, trimethyl-butoxysilane, triphenylmethoxysilane, dimethyl-t-butylmethoxysilane, triphenylethoxysilane, dimethyl-phenylmethoxysilane; dimethyl-dimethoxysilane, dimethyldiethoxysilane, diethyl-dimethoxysilane, diphenyldimethoxysilane, diphenyl-diethoxysilane, methylphenyldimethoxysilane methyl-phenyldiethoxysilane; methyl-trimethoxysilane, methyltriethoxysilane, ethyltri-methoxysilane, phenyltrimethoxysilane phenyltri-ethoxysilane; tetramethoxysilane, tetraethoxysilane and tetraiso-propoxysilane.

15. The coating composition of claim 9 wherein the at least one silane component is selected from the group consisting of adducts of isocyanatoalkyltrialkoxysilanes; aliphatic, alkyl branched diols; and aliphatic, alkyl branched polyols.

16. The coating composition of claim 9 further comprising at least one viscosity modifier, wherein the at least one viscosity modifier comprises at least one solvent selected from the group consisting of hexane, heptane, xylene, toluene, cyclohexane; methyl acetate, ethyl acetate, t-butyl acetate, acetic acid ethylene glycol monomethyl ether, 1,2,3-triacetoxypropane, acetic acid diethylene glycol monomethyl ether, dibasic ester; isopropyl ether, ethylene glycol monomethyl ether, diethylene glycol monobutyl ether; methyl isobutyl ketone, methyl ethyl ketone, isophorone, acetophenone; propylene carbonate, dimethyl carbonate; n-methyl pyrollidone, n-ethyl pyrollidone; parachlorobenzotrifluoride, 1,1,2,2-Tetrachloroethane, and 1,1-Dichloroethane.

17. The coating composition of claim 9 further comprising at least one viscosity modifier, wherein the at least one viscosity modifier comprises at least one non-reacting diluent selected from the group consisting of bis(2-ethylhexyl) phthalate, diisononyl phthalate, butyl benzyl phthalate; dioctyl adipate, dibutyl sebacate, 1,2-Cyclohexane dicarboxylic acid diisononyl ester, 2,2,4-Trimethyl-1,3-pentanediol diisobutyrate, alkyl sulphonic acid phenyl ester; acetyl triethyl citrate, triethyl citrate; trimethyl trimellitate, tri-(2-ethylhexyl) trimellitate, benzoates, sulfonamides, epoxidized vegetable oils, organophosphates, glycols, polyethers, and polybutene.

18. The coating composition of claim 9 further comprising at least one other additive selected from the group consisting of leveling agents, defoamers, air release agents, antioxidants, UV stabilizers, rheology modifier, pigments, dispersants, plasticizers, diluents, fillers and combinations thereof.

19. The coating composition of claim 9 wherein the coating composition is non-aqueous.
